(19) United States
(12) Patent Application Publication
(10) Pub. No.: US 2002/0010238 A1
(43) Pub. Date: Jan. 24, 2002

(54) Ignition resistant polymer compositions

(76) Inventor: Samuel A. Ogoe, Missouri City, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/738,152

(22) Filed: Dec. 15, 2000

Related U.S. Application Data
(60) Provisional application No. 60/181,621, filed on Feb. 10, 2000.

(51) Int. Cl. C08K 5/52; C08K 5/09

(52) U.S. Cl. 524/140; 524/141; 524/394

(57) ABSTRACT

Disclosed is an ignition resistant polymer composition containing a thermoplastic polymer, a phosphorous compound, and an oxalate salt of metals of group I, II or III of the Periodic Table of the Elements. The ignition resistant polymer composition according to the invention is rated V-2, V-1, V-0 or 5 V in the Underwriter's Laboratories Standard 94 flammability test.

### CROSS REFERENCE STATEMENT

This application claims the benefit of U.S. Provisional application Ser. No. 60/181,621, filed Feb. 10, 2000.

### FIELD OF THE INVENTION

This invention relates to ignition resistant polymer compositions comprising a thermoplastic polymer, a phosphorous compound and an oxalate salt of metals of group I, II or III of the Periodic Table of the Elements. This invention relates particularly to halogen-free ignition resistant thermoplastic polymer compositions having a good balance of physical properties and rated V-2, V-1, V-0 or 5 V in the Underwriter's Laboratories Standard 94 flammability test.

### BACKGROUND OF THE INVENTION

Thermoplastic polymer compositions, in particular styrenic-based polymer compositions, are generally rendered ignition resistant by the addition of halogen-containing compounds, for example bromine- and/or chlorine-containing compounds, in particular organic compounds. In recent years, there has been concern regarding halogen-containing flame retardants due to the release of halogen-containing products on burning.

Halogen-free, in particular bromine- and/or chlorine-free, ignition resistant polymer compositions are known, for example, U.S. Pat No. 5,672,645 discloses an ignition resistant polymer blend composition comprising an aromatic polycarbonate, a styrene-containing copolymer, a styrene-containing graft polymer, 20 parts of a mixture of mono- and oligomeric-phosphate flame retardants, and 5 parts fluorinated polyolefin. According to this prior art, high levels of specific phosphate mixtures and a tetrafluoroethylene polymer are required to achieve the desired ignition resistance results. Further, in addition to being a halogen-containing compound, tetrafluoroethylene is known to detrimentally effect physical properties in polycarbonate blend compositions, especially impact strength such as notched Izod impact strength.

U.S. Pat. Re. No. 36,188 discloses an ignition resistant polymer blend composition comprising an aromatic polycarbonate, a styrene-containing copolymer, a styrene-containing graft polymer and 25 parts of an oligomeric-phosphate flame retardant. According to this prior art, the oligomeric phosphate is used in high concentrations and must have a very narrow range of repeating units. When the repeating units for the oligomeric phosphate are outside the disclosed narrow range, the ignition resistant polymer blend compositions have poor S-tensile impact strength. This known polymer blend may moreover comprise a halogen-containing compound.

EP 860,470 discloses a styrene-base polymer, 10 parts of a neutralizing agent chosen from metal oxides, metal hydroxides, or metal carbonates and 25 parts of a phosphate flame retardant. According to this prior art, high levels of specific phosphate flame retardant and metal oxides, metal hydroxides, or metal carbonates are required to achieve the desired ignition resistance results.

The present invention addresses the deficiencies of the conventional halogen-free ignition resistant polymer compositions.

### SUMMARY OF THE INVENTION

It has surprisingly now been found that it is possible to impart ignition resistance to a thermoplastic polymer, in particular a styrene-based polymer or blend of a styrene-based polymer with a polycarbonate polymer, by means of a moderate amount of a phosphorous compound and an effective amount of an oxalate salt of metals of group I, II or III of the Periodic Table of the Elements. Said ignition resistant polymer composition having a good balance of physical properties is rated V-2, V-1, V-0 or 5 V in the Underwriter's Laboratories Standard 94 (UL 94) flammability test.

In another aspect, the present invention is a process for preparing the abovementioned ignition resistant polymer composition by admixing a thermoplastic polymer, in particular a styrene-based polymer or blend of a styrene-based polymer with a polycarbonate polymer, a moderate amount of a phosphorous compound and an effective amount of an oxalate salt of metals of group I, II or III of the Periodic Table of the Elements.

In a further aspect, the present invention involves a method of molding or extruding the abovementioned ignition resistant polymer comprising a thermoplastic polymer, in particular a styrene-based polymer or blend of a styrene-based polymer with a polycarbonate polymer, blended with a moderate amount of a phosphorous compound and an effective amount of an oxalate salt of metals of group I, II or III of the Periodic Table of the Elements.

In yet a further aspect, the invention involves molded or extruded articles of the abovementined ignition resistant polymer composition comprising a thermoplastic polymer, in particular a styrene-based polymer or blend of a styrene-based polymer with a polycarbonate polymer, blended with a moderate amount of a phosphorous compound and an effective amount of an oxalate salt of metals of group I, II or III of the Periodic Table of the Elements.

The ignition resistant polymer compositions of the present invention are especially useful in the preparation of molded objects notably parts required to meet UL 94 V-2 rating or better. These compositions are particularly suited for use in instrument housings such as for power tools, appliances, consumer electronic equipment such as TVs, VCRs, web appliances, electronic books, etc., or information technology equipment such as telephones, computers, monitors, fax machines, battery chargers, scanners, copiers, printers, hand held computers, etc.

### DETAILED DESCRIPTION OF THE EMBODIMENTS

Component (a) in the ignition resistant polymer composition of the present invention is a thermoplastic polymer. The thermoplastic polymer can be a homopolymer or a copolymer. Preferably, the thermoplastic polymer can be a polyolefin (PO) such as polyethylene (PE), polypropylene (PP) and the likes made by conventional Ziegler-Natta or metallocene catalysts; a styrene-based polymer, such as polystyrene (PS), impact modified polystyrene, e.g., high-impact polystyrene (HIPS), or polystyrene copolymers, e.g., styrene and acrylonitrile copolymer (SAN), styrene graft polymers, e.g., acrylonitrile, styrene, and butadiene terpolymer (ABS), or the likes; a polyphenylene oxide (PPO), a polyester such as polybutylene terephthalate (PBT), polyethylene terephthalate (PET), and the likes; a polycarbonate (PC); a polyamide polymer, e.g., nylon; or a thermoplastic polyurethane (TPU, e.g., PELLATHANE™ or ISOPLAST™ made by The Dow Chemical Company).

The styrene-based polymers and copolymers which can be used in the present invention are well know, for example see U.S. Pat. Nos. 4,666,987, 4,572,819, and 4,585,825, which are herein incorporated by reference. Preferably, the monomer is of the formula:

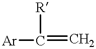

wherein R′ is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Typical vinyl aromatic monomers which can be used include: styrene; alpha-methylstyrene; vinylalkylbenzenes such as all isomers of vinyl toluene, especially para vinyl toluene, and all isomers of vinyl xylene; all isomers of ethyl styrene; propyl styrene; butyl styrene; vinyl biphenyl, vinyl naphthalene, vinyl anthracene and the like, and mixtures thereof. The vinyl aromatic monomers may also be combined with other copolymerizable monomers. Examples of such monomers include, but are not limited to acrylic monomers such as acrylonitrile, methacrylonitrile, methacrylic acid, the lower alkyl esters of methacrylic acid such as methyl methacrylate, acrylic acid, the lower alkyl esters of acrylic acid such as methyl acrylate, maleimide, N-phenylmaleimide and maleic anhydride. In addition, the polymerization of the vinyl aromatic monomer may be conducted in the presence of predissolved elastomer to prepare impact modified, or grafted rubber containing products, examples of which are described in U.S. Pat. Nos. 3,123,655, 3,346,520, 3,639,522, and 4,409,369, which are incorporated by reference herein.

Polymerization processes and process conditions for the polymerization of styrene-base polymers are well known in the art. Although any polymerization process can be used, typical processes are continuous bulk or solution polymerizations as described in U.S. Pat. No. 2,727,884 and U.S. Pat. No. 3,639,372, which are incorporated herein by reference.

Preferred styrene-based polymers are styrene homopolymers, alkylstyrene homopolymers such as alpha-methylstyrene, styrene copolymers and styrene graft polymers.

Preferred copolymers are styrene and acrylonitrile copolymers; styrene and methacrylic ester copolymers; styrene, acrylonitrile and maleic anhydride (SAMA) terpolymers; styrene and maleic anhydride (SAM) copolymers and similar polymers including N-phenyl substituted and differently substituted and similar maleimides, and mixtures thereof. Highly preferred copolymers contain from about 70 to about 80 percent styrene monomer and 30 to 20 percent acrylonitrile monomer.

Preferred styrene graft polymers include impact modified polystyrene polymers, for example high impact polystyrene; acrylonitrile, butadiene and styrene emulsion and/or bulk type polymers; methyl methacrylate, butadiene, acrylonitrile and styrene (MABS) polymers and methyl methacrylate, butadiene and styrene (MBS) polymers. The rubbery polymer backbone in styrene graft polymers normally constitutes from about 5 to about 80 weight percent, preferably from about 5 to about 50 weight percent, of the total weight of the graft polymer. Suitable rubbers include the well known homopolymers and copolymers of conjugated dienes, particularly butadiene, as well as other rubbery polymers such as polyisoprene, nitrile rubber, styrene-diene copolymers such as styrene and butadiene (SB) rubber, olefin polymers, particularly copolymers of ethylene and propylene (EP) rubber and ethylene, propylene and a nonconjugated diene (EPDM) rubber, or acrylate rubbers, particularly homopolymers and copolymers of alkyl acrylates having from 4 to 6 carbons in the alkyl group. In addition, mixtures of the foregoing rubbery polymers may be employed if desired. Preferred rubbers are homopolymers of butadiene and copolymers thereof with up to about 30 percent by weight styrene. Such copolymers may be random or block copolymers and in addition may be hydrogenated to remove residual unsaturation.

The styrene graft polymers such as ABS polymers may be prepared by a graft generating process such as by a bulk or solution polymerization and/or an emulsion polymerization of the copolymer in the presence of the rubbery polymer. In the emulsion polymerization to form graft copolymers of rubbery substrates it is previously known in the art to employ agglomeration technology to prepare large and small rubber particles containing the copolymer grafted thereto. In the process various amounts of an ungrafted matrix of the copolymer are also formed. In the solution or bulk polymerization of a rubber-modified copolymer of a vinyl aromatic monomer, a matrix copolymer is formed. The matrix further contains rubber particles having copolymer grafted thereto and occluded therein.

A particularly desirable product comprises a rubber modified copolymer blend comprising both the mass or solution polymerized rubber modified copolymer and additional quantities of an emulsion polymerized and preferably agglomerated rubber modified copolymer containing a bimodal particle-sized distribution.

The polycarbonate polymers that can be used in the present invention are well known and can be prepared from one or more multihydric compounds by reacting the multihydric compounds, such as an aromatic diol, with a carbonate precursor, such as phosgene, a haloformate or a carbonate ester such as diphenyl or dimethyl carbonate. Preferably the polycarbonate is prepared from one or more aromatic diols such as bisphenol A, tetrabromo bisphenol A, tetramethyl bisphenol A, 1,1-bis(4-hydroxyphenyl)-1-phenylethane, 3,3-bis(para-hydroxyphenyl)phthalide, or bis hydroxyphenylfluorene. The polycarbonates can be prepared from these raw materials by any of several known processes such as the known interfacial, solution or melt processes. As is well known, suitable chain terminators and/or branching agents can be employed to obtain the desired molecular weights and branching degrees. The polycarbonate may be derived from (1) two or more different aromatic diols or (2) an aromatic diol and a glycol or a hydroxy- or acid-terminated polyester or a dibasic acid in the event a polycarbonate copolymer or heteropolymer rather than a homopolymer is desired. Also suitable for the practice of this invention are blends of one or more of the above polycarbonates. Also included in the term polycarbonate are the poly(ester/carbonates).

The thermoplastic polymer component (a) is employed in the ignition resistant compositions of the present invention in amounts of at least about 60 parts, preferably at least about 65 parts, more preferably at least about 70 parts, and most preferably at least about 75 parts based on 100 parts by weight of components (a), (b) and (c). In general the thermoplastic polymer is used in amounts less than or equal to about 99 parts, preferably less than or equal to about 95 parts, more preferably less than or equal to about 90 parts, even more preferably less than or equal to about 85 parts, and most preferably less than or equal to about 80 parts based on 100 parts by weight of components (a), (b) and (c).

Suitable phosphorous compounds employed in the present invention as component (b) are organophosphorous compounds which include organophosphates, organophosphonites, organophosphonates, organophosphites, organophosphinites, organophosphinates, or mixtures thereof. Suitable organophosphorous compounds are disclosed, for example, in U.S. Pat. Re. Nos. 36,188; 5,672,645; and 5,276,077, which are incorporated by reference herein. A preferred organophosphorous compound is a monophosphorous compound represented by Formula I:

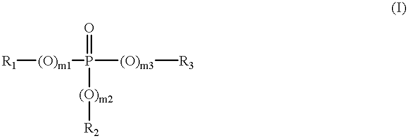

wherein R₁, R₂, and R₃, each represent an aryl or an alkaryl group chosen independently of each other and m1, m2, and m3 each independently of each other are 0 or 1.

Most preferred monophosphorus compounds are monophosphates where m1, m2, and m3 are all 1 and R₁, R₂, and R₃ are independently methyl, phenyl, cresyl, xylyl, cumyl, naphthyl, clorophenyl, bromophenyl, pentachlorophenyl, or pentabromophenyl, for example, trimethyl phosphate, triphenyl phosphate, all isomers of tricresyl phosphate and mixtures thereof, especially tri(4-methylphenyl) phosphate, all isomers of trixylyl phosphate and mixtures thereof, especially tri(2,6-dimethylphenyl) phosphate, tricresyl phosphate, all isomers of tricumyl phosphate and mixtures thereof, trinaphthyl phosphate, all isomers of tri(chlorophenyl) phosphate and mixtures thereof, all isomers of tri(bromophenyl) phosphate and mixtures thereof, tri(pentachlorophenyl) phosphate, tri(pentabromophenyl) phosphate, or mixtures thereof.

Another preferred organophosphorous compound is an multiphosphorous compound represented by Formula II:

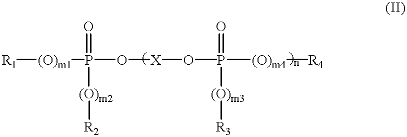

wherein R₁, R₂, R₃, and R₄ each represent an aryl or an alkaryl group chosen independently of each other, X is an arylene group derived from a dihydric compound, m1, m2, m3, and m4 each independently of each other are 0 or 1 and n has an average value greater than 0 and less than 10, when n is equal to or greater than 1 these multiphosphorous compounds are sometimes referred to as oligomeric phosphorous compounds.

Preferred multiphosphorous compounds are multiphosphates where m1, m2, m3, and m4 are 1, R₁, R₂, R₃, and R₄ are independently methyl, phenyl, cresyl, xylyl, cumyl, naphthyl, clorophenyl, bromophenyl, pentachlorophenyl, or pentabromophenyl, X is an arylene group derived from a dihydric compound, for example, resorcinol, hydroquinone, bisphenol A and chlorides and bromides thereof, and n has an average value greater than 0 and less than about 5, preferably n has an average value greater than about 1 and less than about 5. For example preferred oligomeric phosphates having an n value between about 1 and about 2 are m-phenylene-bis(diphenylphosphate), p-phenylene-bis(diphenylphosphate), m-phenylene-bis(dicresylphosphate), p-phenylene-bis(dicresylphosphate), m-phenylene-bis(dixylylphosphate), p-phenylene-bis(dixylylphosphate), Bis phenol-A-bis(diphenylphosphate), Bis phenol A-bis(dicresylphosphate), Bis phenol A-bis(dixylylphosphate), or mixtures thereof.

A most preferred phosphorous compound is a mixture of one or more monophosphorous compounds of Formula I and one or more multiphosphorous compounds of Formula II.

The phosphorous compound component (b) is employed in an amount sufficient for the ignition resistant compositions of the present invention to meet UL 94 V-2, V-1, V-0 or 5 V requirements, in an amount of at least about 0.1 part, preferably at least about 1 part, more preferably at least about 2.5 parts, even more preferably at least about 5 parts, and most preferably at least about 10 parts based on 100 parts by weight of components (a), (b) and (c). In general the phosphorous compound is used in amounts less than or equal to about 30 parts, preferably less than or equal to about 25 parts, more preferably less than or equal to about 20 parts, even more preferably less than or equal to about 15 parts, and most preferably less than or equal to about 10 parts based on 100 parts by weight of components (a), (b) and (c).

Component (c) of the present invention is an oxalate salt of metals of group I, II or III of the Periodic Table of the Elements. Preferred metals are aluminum, calcium and magnesium. Preferred oxalate salts comprise one or more oxalate moiety and may optionally be hydrated. For example, preferred oxalate salts are aluminum oxalate (Al₂(C₂O₄)₃), calcium oxalate (CaC₂O₄), magnesium oxalate (MgC₂O₄) or mixtures thereof. Most preferred is basic aluminum oxalate (BAO) available from Alcoa represented by Formula III:

(Al)₂(OH)₄(C₂O₄) (III)

The oxalate salt of metals of group I, II or III of the Periodic Table of the Elements component (c) is employed in an amount sufficient for the ignition resistant compositions of the present invention to meet UL 94 V-2, V-1, V-0 or 5 V requirements, preferably in an amount of at least about 0.1 part, preferably at least about 1 part, more preferably at least about 2.5 parts, even more preferably at least about 5 parts, and most preferably at least about 10 parts based on 100 parts by weight of components (a), (b) and (c). In general the oxalate salt of metals of group I, II or III of the Periodic Table of the Elements is used in amounts less than or equal to about 30 parts, preferably less than or equal to about 25 parts, more preferably less than or equal to about 20 parts, even more preferably less than or equal to about 15 parts, and most preferably less than or equal to about 10 parts based on 100 parts by weight of components (a), (b) and (c).

In addition, the ignition resistant polymer compositions may also optionally contain one or more additives that are commonly used in polymers of this type. Preferred additives of this type include, but are not limited to: antioxidants; impact modifiers; plasticizers, such as mineral oil; antistats; flow enhancers; mold releases; fillers, such as calcium carbonate, talc, clay, mica, wollastonite, hollow glass beads, titaninum oxide, silica, carbon black, glass fiber, potassium titanate, single layers of a cation exchanging layered silicate material or mixtures thereof; and ignition resistance additives such as, but not limited to a halogen-containing low-molecular weight compound and/or high molecular weight polymers, such as halogenated hydrocarbons, halogenated carbonate oligomers, halogenated diglycidyl ethers, perfloroalkane oligomers and polymers, metal compounds active as a synergist, such as antimony oxide, salts having flame-retarding properties such as metal salts of aromatic sulfur containing compounds or a mixture thereof, etc. Further, compounds which stabilize ignition resistant polymer compositions against degradation caused by, but not limited to heat, light, and oxygen, or a mixture thereof may be used.

If used, such additives may be present in an amount from at least about 0.01 percent by weight, preferably at least about 0.1 percent by weight, more preferably at least about 1 percent by weight, even more preferably at least about 2 percent by weight, and most preferably at least about 5 percent by weight based on the total weight of the ignition resistant polymer composition. Generally, the additive is present in an amount less than or equal to about 25 percent by weight, preferably less than or equal to about 20 percent by weight, more preferably less than or equal to about 15 percent by weight, even more preferably less than or equal to about 12 percent by weight, and most preferably less than or equal to about 10 percent by weight based on the total weight of the ignition resistant polymer composition.

UL 94 vertical (V) flammability test determines the upward-burning characteristics of a solid. Five test specimens, of a desired thickness measuring 12.5 millimeter (mm) by 125 mm, suspended vertically over surgical cotton are ignited by a 18.75 mm Bunsen burner flame; two ignitions of 10 seconds each are applied to the samples. The rating criteria include the sum of after-flame times after each ignition, glow time after the second ignition, and whether the bar drips flaming particles that ignite the cotton. Table I lists the criteria for each V rating.

TABLE I

| Rating* | V-2 | V-1 | V-0 |
|---|---|---|---|
| Max individual burn time | ≦30 | ≦30 | ≦10 |
| Burn time of 5 test specimens | ≦250 | ≦250 | ≦50 |
| Glow time after second ignition | ≦60 | ≦60 | ≦30 |
| Ignites cotton | Yes | No | No |

*Rating criteria are reported in seconds

The UL 94 5 V flammability test utilizes a 125 mm Bunsen burner flame held at an angle of 20° to a test specimen, of a desired thickness measuring 12.5 mm by 125 mm, suspended vertically over surgical cotton, for 5 seconds, then away from it for 5 seconds, alternating in this pattern for five applications of the flame. After completion of the fifth ignition, the burning time must not exceed 60 seconds to achieve a 5 V rating, nor can the cotton be ignited by flaming drips.

Preparation of the ignition resistant polymer compositions of this invention can be accomplished by any suitable mixing means known in the art, including dry blending the individual components and subsequently melt mixing, either directly in the extruder used to make the finished article or pre-mixing in a separate extruder (e.g., a Banbury mixer). Dry blends of the compositions can also be directly injection molded without pre-melt mixing.

The ignition resistant polymer compositions of this invention are thermoplastic. When softened or melted by the application of heat, the ignition resistant polymer compositions of this invention can be formed or molded using conventional techniques such as compression molding, injection molding, gas assisted injection molding, calendering, vacuum forming, thermoforming, extrusion and/or blow molding, alone or in combination. The ignition resistant polymer compositions can also be formed, spun, or drawn into films, fibers, multi-layer laminates or extruded sheets, or can be compounded with one or more organic or inorganic substances, on any machine suitable for such purpose. Some of the fabricated articles include instrument housings such as for power tools, appliances, consumer electronic equipment such as TVs, VCRs, web appliances, electronic books, etc., or information technology equipment such as telephones, computers, monitors, fax machines, battery chargers, scanners, copiers, printers, hand held computers, etc.

### EXAMPLES

To illustrate the practice of this invention, examples of preferred embodiments are set forth below. However, these examples do not in any manner restrict the scope of this invention.

The compositions of Examples 1 to 7 were prepared by mixing ABS polymer pellets and other additives in a tumble blender for about 10 minutes. The dry blended mixture was fed to a 30 mm Werner and Pfleider fully intermeshing corotating twin screw extruder. The following conditions were used on the Werner and Pfleider extruder: all barrel temperature zones were set at 220° C. giving a melt temperature of 205° C. to 227° C.; RPMs were 200, torque was 70 to 80 percent, and the feed rate was 50 pounds per hour. The extrudate was cooled in the form of strands and comminuted as pellets. The pellets were dried in an air draft oven for 3 hours at 70° C. and then were used to prepare 1.6 mm and 3.2 mm thick test specimens on a 70 ton Arburg injection molding machine. The following conditions were used on the Arburg injection molding machine: all barrel temperature zones were at 220° C. giving a melt temperature of 225° C., injection pressure was 55 bar, holding pressure was 30 bar, back pressure was 10 bar, screw speed was 3.0, injection speed was 4.0, cycle time was 25 seconds, cooling time was 10 seconds, dosage was 13.1, and the mold temperature was 40° C.

The compositions of Examples 8 to 11 were prepared by pre-mixing PC polymer flake and the TEFLON in a small container, then PC polymer pellets dried at 100° C. for at least 4 hours, ABS polymer pellets, the pre-mixed PC/TEFLON and other additives were mixed in a tumble blender for about 10 minutes. It is not necessary to dry the PC pellets if a vented extruder or vacuumed extruder is used. The dry blended mixture was fed to a 30 mm Werner and Pfleider fully intermeshing corotating twin screw extruder. The following conditions were used on the Werner and Pfleider extruder: all barrel temperature zones were set at 240° C. giving a melt temperature of 243° C. to 254° C.; RPMs were 400, torque was 80 to 90 percent, and the feed rate was 50 pounds per hour. The extrudate was cooled in the form of strands and comminuted as pellets. The pellets were dried in an air draft oven for 3 hours at 90° C. and then were used to prepare 1.6 mm and 3.2 mm thick test specimens on a 70 ton Arburg injection molding machine. The following conditions were used on the Arburg injection molding machine: all barrel temperature zones were at 270° C. giving a melt temperature of 275° C., injection pressure was 50 bar, holding pressure was 45 bar, back pressure was 10 bar, screw speed was 3.0, injection speed was 4.0, cycle time was 35 seconds, cooling time was 20 seconds, dosage was 13.1, and the mold temperature was 50° C.

The formulation content and properties of Examples 1 to 11 are given in Table II below in parts by weight of the total composition. In Table II:

“PC” is a bisphenol-A polycarbonate homopolymer having a melt flow of 22 and commercially available as CALIBRE™ 300-22 from The Dow Chemical Company;

“ABS” is a mass produced acrylonitrile butadiene styrene terpolymer having about 19 percent acrylonitrile and about 10.5 percent butadiene rubber available as MAGNUM ABS 941 from The Dow Chemical Company;

“TPP” is triphenyl phosphate available from Akzo/Nobel;

“BAO” is basic aluminum oxalate available from Alcoa Industrial Chemicals;

“TEFLON™ 6C” is fibril forming tetrafluoroethylene polymer powder available from DuPont Chemical Company; and

“IRGANOX™ 1076” is a phenolic antioxidant available from Ciba Geigy.

The following tests were run on Examples 1 to 11 and the results of these tests are shown in Table II:

“UL 94” flammability test was performed on 1.6 mm test specimens;

“MFR” was determined according to ASTM D 1238 on a Tinius Olsen plastometer at 230° C. and an applied load of 3.8 kg.;

“Izod” impact resistance as measured by the Notched Izod test was determined according to ASTM D 256-90-B at 23° C. Specimens were cut from rectangular DTUL bars and measured 3.18 mm in thickness and 50.8 mm in length. The specimens were notched with a TMI 22-05 notcher to give a 0.254 mm radius notch. A 22 kilogram pendulum was used, values are reported in Joules per meter (J/m);

“DTUL” is deflection temperature under load determined on a Ceast HDT 300 Vicat machine in accordance with ASTM D 648-82 where test specimens were unannealed and tested under an applied pressure of 0.46 megapascals (MPa);

“Flexural Modulus” was determined in accordance with ASTM D 790. Testing was performed using an INSTRON™ mechanical tester. Flexural property test specimens were conditioned at 23° C. and 50 percent relative humidity 24 hours prior to testing. Testing was performed at room temperature; and

“Tensile Properties” were determined in accordance with ASTM D 638. Tensile Type 1 test specimens were conditioned at 23° C. and 50 percent relative humidity 24 hours prior to testing. Testing was performed using an INSTRON 1125 mechanical tester. Tensile testing was performed at room temperature.

TABLE II

| Example | 1 | 2 | 3 | 4 | 5 | 6* | 7* | 8 | 9* | 10* | 11* |
|---|---|---|---|---|---|---|---|---|---|---|---|
| Composition | | | | | | | | | | | |
| PC | | | | | | | | 67.4 | 75.4 | 71.4 | 79.4 |
| ABS | 84.8 | 79.8 | 74.8 | 84.4 | 79.8 | 80 | 80 | 16.9 | 18.9 | 17.9 | 19.9 |
| BAO | 10 | 10 | 10 | 5 | 5 | 20 | | 10 | | 10 | |
| TPP | 5 | 10 | 15 | 10 | 15 | | 20 | 5 | 5 | | |
| TEFLON 6C | | | | | 0.3 | | | 0.5 | 0.5 | 0.5 | 0.5 |
| IRGANOX 1076 | 0.2 | 0.2 | 0.2 | 0.2 | 0.2 | | | 0.2 | 0.2 | 0.2 | 0.2 |
| Properties | | | | | | | | | | | |
| UL 94 at 1.6 mm | V-2 | V-2 | V-2 | V-2 | V-2 | NR | NR | V-0 | NR | NR | NR |
| Total burn time, s | 200 | 147 | 89 | 104 | 80 | >250 | >250 | 10 | >250 | 213 | >250 |
| Flaming drips | Yes | Yes | Yes | Yes | Yes | | | No | Yes | Yes | Yes |
| Max individual burn time, s | 27 | 18 | 16 | 19 | 17 | | | 2 | | >13 | |
| MFR at 230° C./3.8 Kg, g/10 min | 3.8 | 7.1 | 16.6 | 11.2 | 17.2 | | | | | | |
| Izod, J/m | 155 | 144 | 128 | 155 | 187 | | | | | | |
| DTUL at 0.46 MPa, ° C. | 79.6 | 67.7 | 60.5 | 68.6 | 59.9 | | | | | | |
| Flexural Modulus, Mpa | 1654 | 2274 | 2205 | 2274 | 2136 | | | | | | |
| Tensile Properties | | | | | | | | | | | |
| Yield Strength, MPa | 27.9 | 22.7 | 19.3 | 22.7 | 19.9 | | | | | | |
| Yield Elongation, % | 2.5 | 1.8 | 1.6 | 1.9 | 1.8 | | | | | | |
| Break Strength, MPa | 19.9 | 17.2 | 13.8 | 16.5 | 14.5 | | | | | | |
| Break Elongation, % | 9.3 | 33.8 | 44.8 | 3,600 | 55,9 | | | | | | |

*Not an example of the present invention
NR = not rated

What is claim is:

1. An ignition resistant polymer composition comprising (a) a thermoplastic polymer, (b) a phosphorous compound and (c) an oxalate salt of metals of group I, II or III of the Periodic Table of the Elements, said composition is rated V-2, V-1, V-0, or 5 V in the Underwriter's Laboratories Standard 94 flammability test.

2. The ignition resistant polymer composition of claim 1 wherein the thermoplastic polymer is a polyethylene polymer, a polypropylene polymer, a styrene-based polymer; a polyphenylene oxide polymer; a polyester polymer, a polycarbonate polymer; a polyamide polymer, or mixture thereof.

3. The ignition resistant polymer composition of claim 1 wherein the thermoplastic polymer is high-impact polystyrene polymer; an acrylonitrile, butadiene, styrene terpolymer or a polycarbonate polymer, or mixtures thereof.

4. The ignition resistant polymer composition of claim 1 wherein the thermoplastic polymer is an acrylonitrile, butadiene, and styrene terpolymer.

5. The ignition resistant polymer composition of claim 1 wherein the thermoplastic polymer is a blend of an acrylonitrile, buatadiene, and styrene terpolymer and a polycarbonate polymer.

6. The ignition resistant polymer composition of claim 1 wherein the phosphorous compound is chosen from the monophosphorous compounds represented by Formula I: 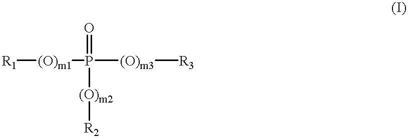
wherein R₁, R₂, and R₃, each represent an aryl or an alkaryl group chosen independently of each other and m1, m1, and m3 each independently of each other are 0 or 1.

7. The ignition resistant polymer composition of claim 1 wherein the phosphorous compound is chosen from the multiphosphorous compounds represented by Formula II: 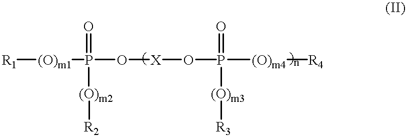
wherein R₁, R₂, R₃, and R₄ each represent an aryl or an alkaryl group chosen independently of each other, X is an arylene group derived from a dihydric compound, m1, m2, m3, and m4 each independently of each other are 0 or 1 and n has an average value greater than 0 and less than about 10.

8. The ignition resistant polymer composition of claim 1 wherein the phosphorous compound is a mixture of one or more monophosphorous compounds of Formula I and one or more multiphosphorous compounds of Formula II.

9. The monophosphorous compound of claim 6 wherein R₁, R₂, and R₃, each represent phenyl or 2,6-dimethylphenyl and m1, m2, and m3 each represent 1.

10. The multiphosphorous compound of claim 7 wherein R₁, R₂, R₃, and R₄ each represent phenyl or 2,6-dimethylphenyl; X is an arylene group derived from resorcinol, hydroquinone or bisphenol A; m1, m2, m3, and m4 each represent 1; and n has an average value of greater than about 1 and less than about 5.

11. The ignition resistant polymer composition of claim 1 wherein the oxalate salt is a basic aluminum oxalate represented by Formula (III):
(Al)₂(OH)₄(C₂O₄) (III)

12. The ignition resistant polymer composition of claim 1 comprising from about 60 to about 99 parts by weight of component (a), from about 1 to about 20 parts by weight of component (b), and from about 1 to about 20 parts by weight of component (c), parts by weight based on the combined weight of (a)+(b)+(c).

13. The ignition resistant polymer composition of claim 1 further comprising one or more of the following flame retardant additives:
(i) a perfloroalkane oligomer or polymer,
(ii) a metal salt having flame-retarding properties,
(iii) a halogen-containing low-molecular weight compound and/or high molecular weight polymer, and/or
(iv) a metal compound active as a synergist.

14. A method for preparing an ignition resistant polymer composition comprising the step of combining:
(a) a thermoplastic polymer,
(b) a phosphorous compound, and
(c) an oxalate salt of metals of group I, II or III of the Periodic Table of the Elements,
wherein said composition is rated V-2, V-1, V-0, or 5 V in the Underwriter's Laboratories Standard 94 flammability test.

15. The method of claim 14 wherein the thermoplastic polymer is an acrylonitrile, butadiene, and styrene terpolymer, a polycarbonate polymer or mixtures thereof.

16. A method for producing a molded or extruded article of an ignition resistant polymer composition comprising the steps of:
(A) preparing an ignition resistant polymer composition comprising the step of combining:
(a) a thermoplastic polymer,
(b) a phosphorous compound, and
(c) an oxalate salt of metals of group I, II or III of the Periodic Table of the Elements,
wherein said composition is rated V-2, V-1, V-0, or 5 V in the Underwriter's Laboratories Standard 94 flammability test
and
(B) molding or extruding said ignition resistant polymer composition into a molded or extruded article.

17. The method of claim 16 wherein the molded or extruded article is selected from the group consisting of housings for power tools, appliances, TVs, VCRs, web appliances, electronic books, computers, monitors, fax machines, battery chargers, scanners, copiers, printers, or hand held computers.

18. The composition of claim 1 in the form of a molded or extruded article.

19. The molded or extruded article of claim 16 is selected from the group consisting of power tools, appliances, TVs, VCRs, web appliances, electronic books, computers, monitors, fax machines, battery chargers, scanners, copiers, printers, or hand held computers.
